(19) United States
(12) Patent Application Publication
(10) Pub. No.: US 2017/0142931 A1
(43) Pub. Date: May 25, 2017

(54) Ergonomic, anatomically-shaped, textured palmar surfaced glove with a comb-like, raised nodule palm-pattern for grooming and bathing domesticated animals

(71) Applicants: Jay Michaelson, Mansfield, TX (US); Summer Finley Kelly, Lakeway, TX (US); Steven Gotcher, Austin, TX (US)

(72) Inventors: Jay Michaelson, Mansfield, TX (US); Summer Finley Kelly, Lakeway, TX (US); Steven Gotcher, Austin, TX (US)

(21) Appl. No.: 14/723,998

(22) Filed: May 28, 2015

Related U.S. Application Data
(60) Provisional application No. 62/004,105, filed on May 28, 2014.

(51) Int. Cl. A01K 13/00; B29C 51/26; B29C 45/17; A41D 19/00; B29C 45/16

(52) U.S. Cl. CPC A01K 13/001; A01K 13/002; A41D 19/00; B29C 45/16; B29C 45/1701; B29C 51/26; B29K 2027/06

(57) ABSTRACT

A glove for grooming an animal may include a first surface having a first nodule, a second surface having a second nodule and a third surface having substantially no nodules.

### PRIORITY

The present invention claims priority based on 35 USC section 119 and provisional application 62/004,105 which was filed on May 28, 2014.

### FIELD OF THE INVENTION

The present invention relates to a flexible glove and more particularly to a flexible glove which may be used to wash, comb and other functions an animal.

### BACKGROUND

Bathing mitts and curry combs may be purchased in the US market today.

In addition to basic hygiene, bathing and grooming enhances an animal's physical appearance for various competitive events including show competitions, skill and ability competitions and owner satisfaction. Curry combs and bathing mitts are among some of the only animal grooming product options presently available in the US general marketplace.

A curry comb is a tool made of rubber, wood, metals or plastic with “nodules” or “teeth” on the rubbing or combing surface side. The curry comb is grasped in a clamping manner with your fingers and slides onto the palm of the hand during use. It is usually the first tool used in daily grooming; it is generally used in a circular motion to work loose embedded shedding hair or other material in the animal's hair or fur coat or covering overlay.

Curry combs are generally not adequate cleaning tools for use on the animal's legs, face and head, because they are too harsh and may damage delicate skin in these areas.

Bathing mitts are a glove-like mitten hand covering with two sections, one for the thumb and the other section covering all four fingers of the hand like a sack or bag. Some of these bathing mitts have raised-nobs or nubs of various styles or design on one or both sides of the mitt.

Bathing mitts are typically designed as “one-size fits all” which are problematic to use as instructed because they do not anatomically or ergonomically correctly fit human hands. This makes grooming with them very difficult when using these mitts to facilitate a proper deep cleaning.

Soap and water applications with these style of mitts presents even more user difficulties; these mitts generally easily slip off your hand when they are wet during use due to the lack of a wrist retainer strap and poor mitt sizing options. Bathing mitts are not designed to groom contours or tight spots upon the animal's legs, faces and heads.

U.S. Pat. No. 5,009,195 discloses brushes made with metal, wood or plastic handles and containing bristles of natural or synthetic materials (eg. boar, plastic, rubber, metal etc.) being used to groom an animal's coat. The sharp edges and hard handles of many of these devices tend to hurt a squirming animal, which then attempts to escape before a proper grooming job can be accomplished, adding further frustrations to the procedure as the groomer attempts harsher measures to hold the animal in place. The existing bristles can be another source of discomfort as they are varyingly too stiff, sharp or pointed, or have a one directional bend in their tips which promotes snagging on tangled fur. Certain rubber devices on the market today, pull hair painfully, again prodding the animal to attempt a quick get-away to escape the grooming.

There are several one-size-fits-all grooming gloves of varying materials on the market which are ineffective in one or more respects. None have adjusting means whereby the glove can be made to fit snugly, and as a result they slip around on the hand becoming less effective during bathing or brushing. Or their large size, extending cumbrously over the groomer's hand, frightens the animal away. None have adequate bristle structures to do a competent grooming job.

In addition, the expansiveness of their bristle surface makes loosened hair removal difficult and time consuming.

In general, the prior existing devices require many more strokes for grooming because these brushes or oversized “gloves” have a flat, barely flexible surface which cannot adequately make contact with the round legs, tails and stomach areas of curved animal bodies. The animal's patience is tried and it attempts to run away.

### SUMMARY

The present invention is a unique textured palm-pattern designed work glove to be used as a tool for grooming and bathing for all domestic animals.

The object of the present glove relates generally to a textured palm-pattern work glove design and specifically to introduce a palm-pattern configuration to create a hand-shaped, anatomically correct palm-pattern grooming glove work surface. The present invention is adaptable to facilitate various gloved hand functional actions such as, but not limited to, cleaning, scrubbing, combing, currying and grooming domesticated animals. Optional palm design adaptations are possible for sorting, grading, sizing, gardening and cultivating cross-industry work gloves.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the glove of the present invention;

FIG. 2 illustrates another perspective view of the glove of the present invention;

FIG. 3a illustrates a palm view of the glove of the present invention;

FIG. 3b illustrates a curved finger of the glove of the present invention;

FIG. 3c illustrates a straight finger of the glove of the present invention;

FIG. 4a illustrates the first palmar surface layout of the present invention;

FIG. 4b illustrates the second palmar surface layout of the present invention;

FIG. 5a illustrates a glove liner placed over a hand mandrel;

FIG. 5b illustrates a glove liner placed over a hand mandrel;

FIG. 6 illustrates a Palm pattern impression on the concave side of the vacuum injection mold;

FIG. 7 illustrates the convex side of the vacuum injection mold;

FIG. 8 illustrates the nitrate dipping VAT of the present invention;

FIG. 9 illustrates a perspective view of the Palm pattern grooming glove of the present invention;

FIG. 10a illustrates a side view of the first nodule of the present invention;

FIG. 10b illustrates a side view of the second nodule of the present invention.

### DETAILED DESCRIPTION

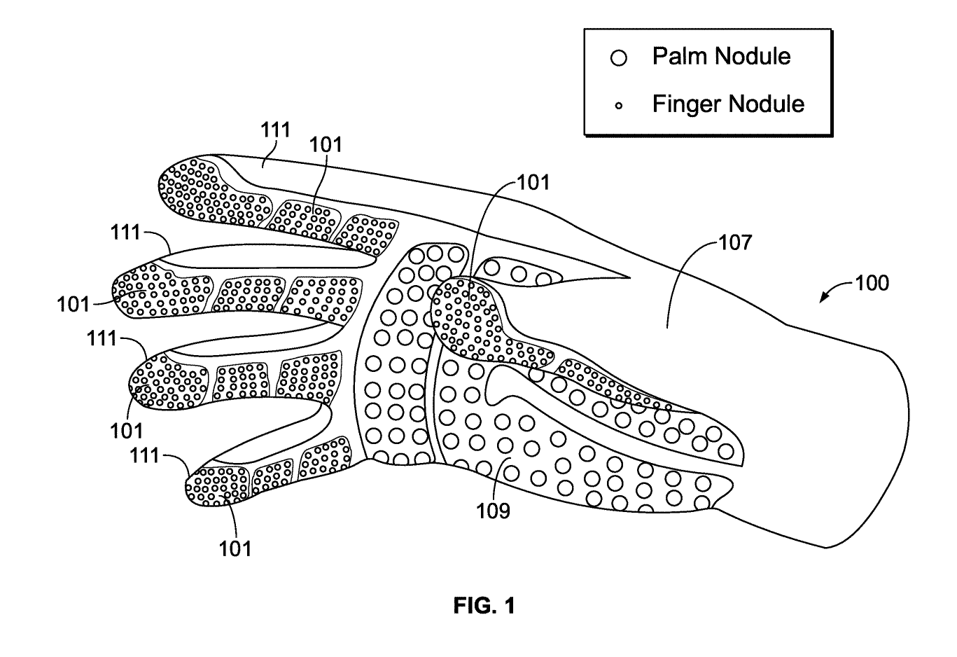

FIG. 1 illustrates the textured glove 100 of the present invention which may include a first surface 101 which may be positioned on selected areas of the finger 111 and/or the thumb 107 and which may include first nodules 115, a second surface 103 which may be positioned on selected areas of the Palm/wrist 109 and which may include a second nodules 117 and a third surface 105 which may have no nodules and which may be positioned on selected areas which do not include the first surface 101 and the second surface 103. The position of the first nodules 115 and a second nodules 117 may be reversed as described above. The first nodules 115 and the second nodules 117 may be completely flexible or completely rigid or may be a next combination of flexible and rigid first nodules and second nodules.

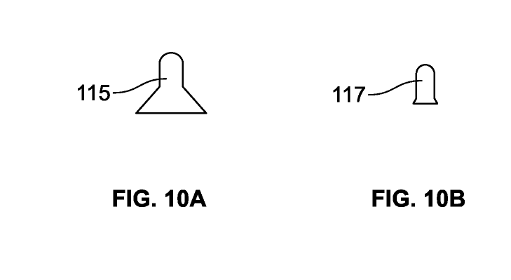

FIG. 10 illustrates the first nodule 115 and the second nodule 117, and the first nodule 115 may include a truncated cone base with an upward extending cylinder finger position on the truncated cone base. The second nodule 117 may be cone shaped.

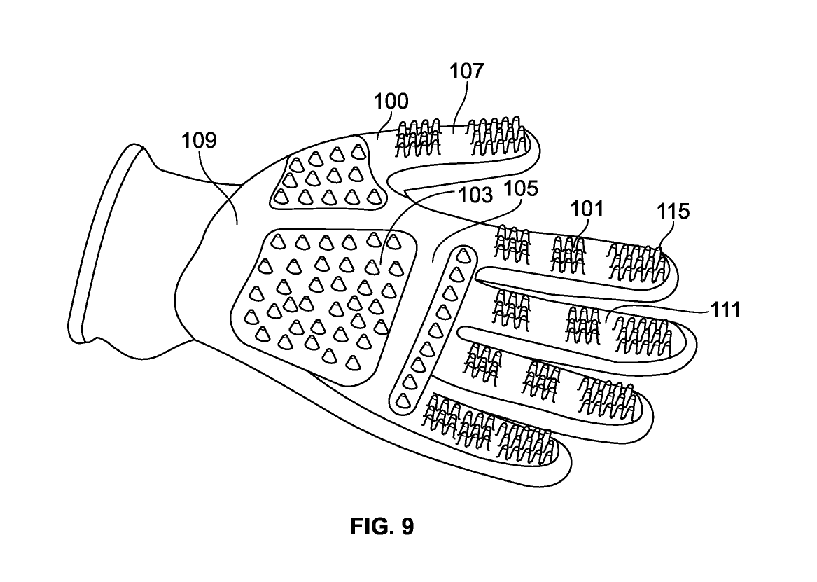

The present invention includes the manufacturing process of an ergonomic, anatomically-shaped glove with a textured palmar surface of comb-like, raised nodules 115, 117 to create a segmented palm-pattern work surface on a glove 100 designed for grooming and bathing domesticated animals. See FIG. 9.

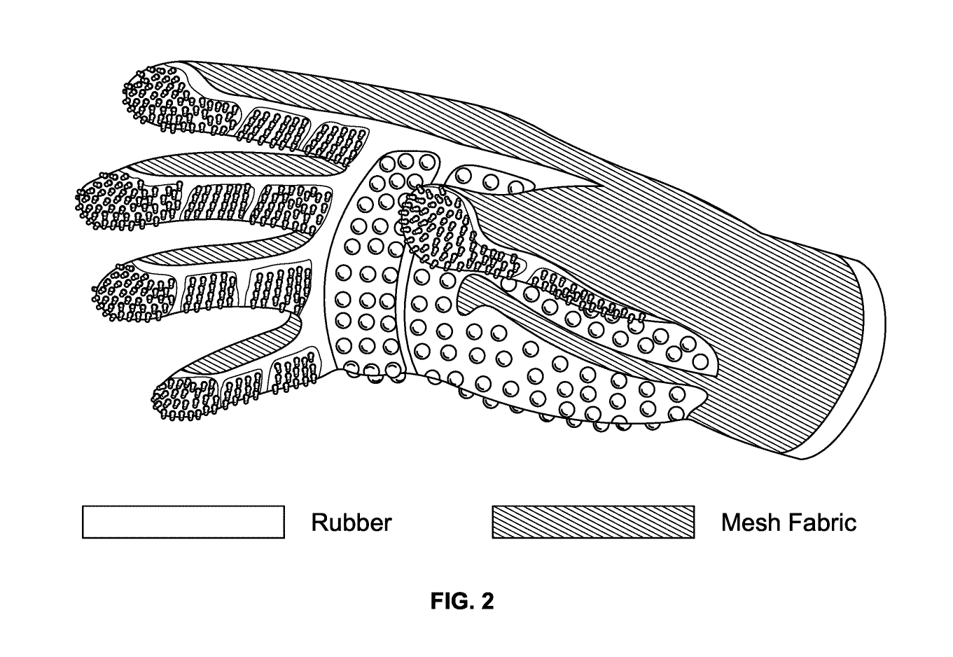

A prototype glove 100 demonstrates the design of new palm patterned grooming glove 100 by cutting out and shaping the general hand palm pattern parts, including the fingers 111, thumb 107 and central palm 109 areas with nub or nodule (115, 117) comb-like spaced anatomical patterns. The prototype glove 100 illustrates the present invention with the anatomically-shaped glove 100 with a textured palmar surface. See FIGS. 1, 2 & 3a,b,c

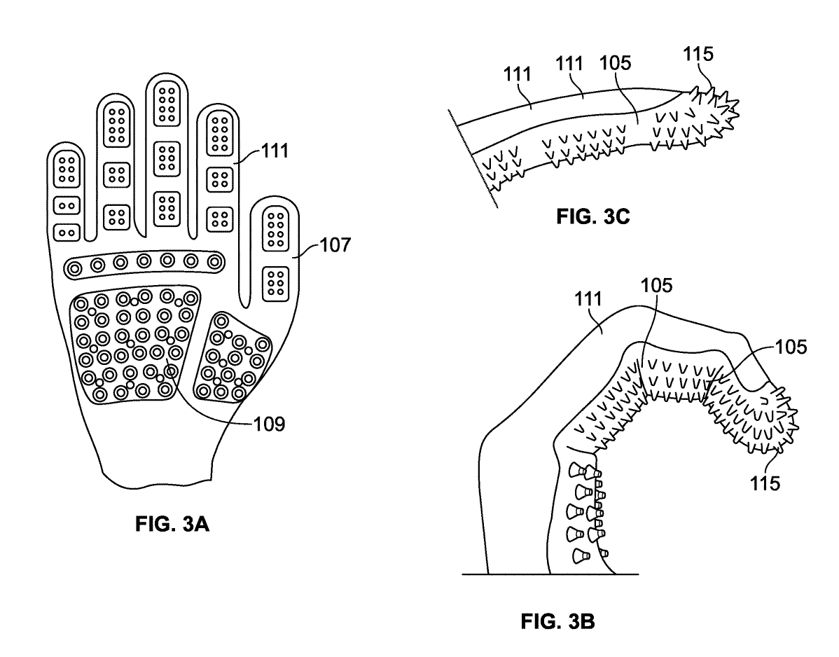

FIG. 3a illustrate space in the form of the third surface 105, while FIG. 3b illustrates that spaces between the first surface 101 allow the finger 111 to be easily pivoted and while FIG. 3a illustrates that spaces between the first surface 101 allow the finger 111 to be easily returned to its original position.

This glove 100 is designed for, but not limited to; combing, grooming, currying and massage applications for domestic animals.

The process of vacuum injection molding is well known and documented in the prior art of numerous industries including glove manufacture.

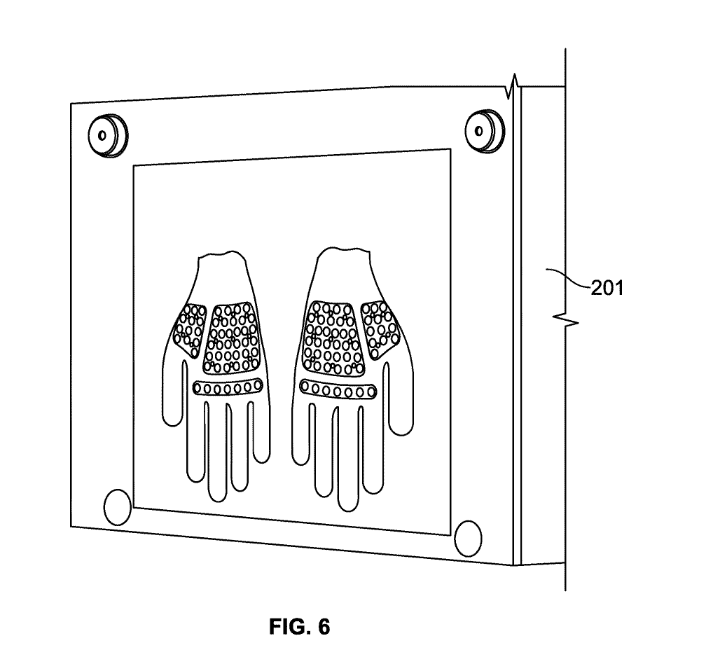

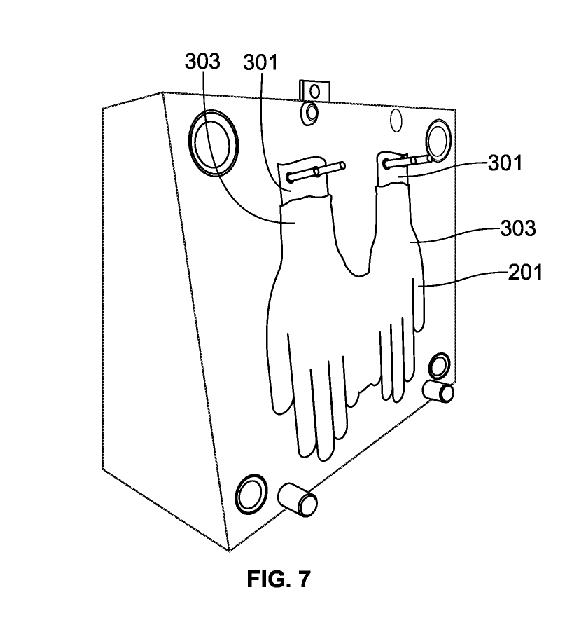

The present invention utilizes design and manufacture vacuum injection molds 201 to form and duplicate the raised nodule (115, 117) comb-like palm patterns, which are integral parts of the grooming glove 100 and design concept. See FIGS. 6 & 7; more particularly, FIG. 6 illustrates the palm pattern impression concave side of the vacuum injection mold 201, and FIG. 7 illustrates the palm pattern impression convex side of the vacuum injection mold 201.

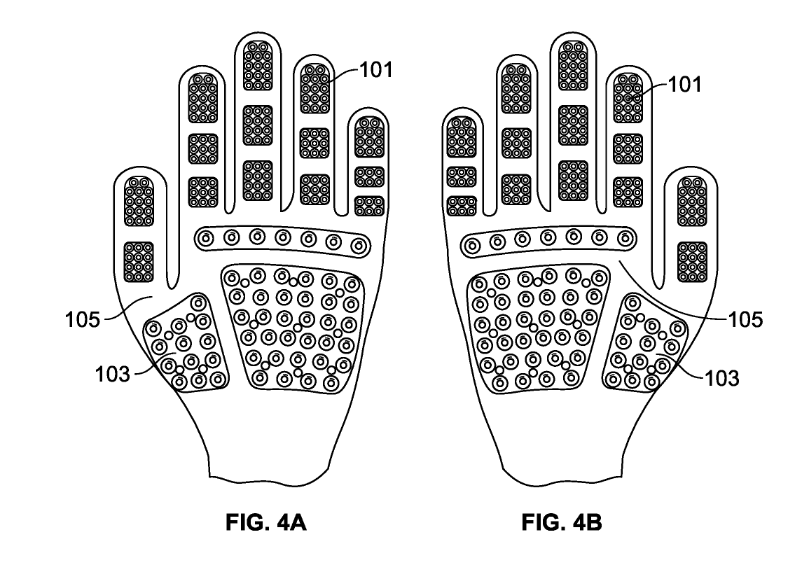

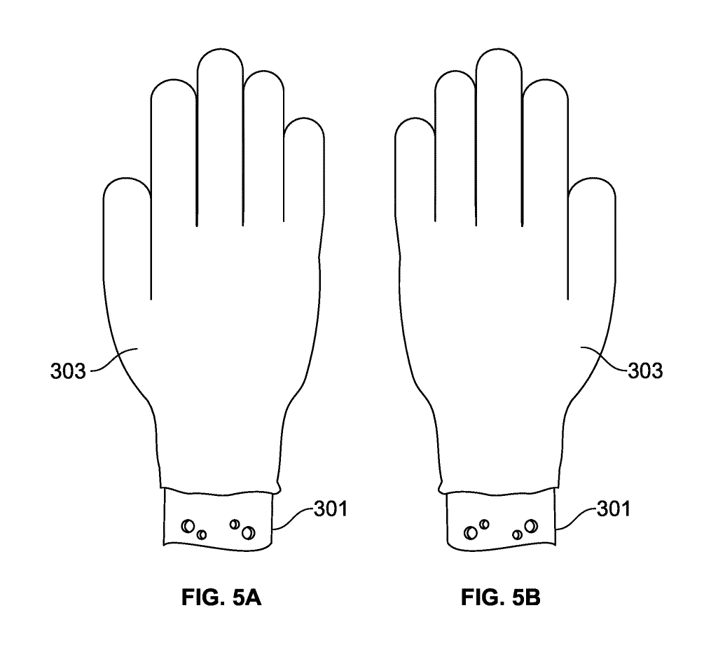

Subsequently, the present invention may utilize the palm patterns with CAD/CAM software drawings useful for fabricating and machining the investment molds and vacuum injection mold 201 such as prototype molds to facilitate the manufacture of the nodule (115, 117) comb-like palm pattern segments. These vacuum molds 201 are used to mass produce by duplication the comb-like scrubbing surfaces on the palm, fingers and thumb surfaces (101, 103, 105) of the grooming glove 100 of the present invention. See FIGS. 3 & 4. FIG. 4 illustrates a manufacturing example of CAD/CAM style drawings to illustrate the palmar surface layout for the injection mold fabrication of the Palm pattern, and FIG. 5 illustrates a glove liner 303 is placed over a hand shaped mandrel 301

The overlaid glove palm pattern design can be vacuum injection molded onto a woven glove liner 303 or invested into the molded glove base liner 303 layer while performing the vacuum injection molding of the palm pattern into the gloves base liner's fabric weave texture. The present invention can be extruded upon or within the fabric glove liner material base 303 of composite liner material which has been used to create the multi-layered glove 100 by applying a multitude of fabric or plastic dipped layers materials suitable for manufacturing over laid surfaces on the glove liners 303. See FIGS. 5, 6 & 7, more particularly, FIG. 5 illustrates the glove liner 303 positioned over the hand shaped mandrel for insertion into the vacuum injection mold.

The present invention can also be accomplished by forming the molded patterns into the mold design of any vacuum injection mold featuring the formed glove molded pattern using nitrile, silicone, PVC, or various other structural combinations of diverse glove plastic polymer materials. Using vacuum injection molding of functionally similar palm pattern designs allows the glove design to be duplicated for quality controlled consistent reproduction.

By altering the shape, design and functionality of the various shaped palm pattern nodules (115, 117), the design of the present invention can be used or applied for numerous functional glove products such as gardening, cultivating, seed sorting, bean, pea or seed size grading, human massage, and automotive uses where mechanical raised nodule palm patterned gloves are advantageous. These stated industrial glove styles identify only some of the examples or possibilities of the glove-use design palm pattern. It should be understood that the present invention is not limited to these example categories.

The present invention may form paired hand-shaped glove mandrels 301 in the shape of various sized human hand shaped mandrels 301 to facilitate various steps of the glove assembly and manufacturing processes which are used to maintain tolerances and a consistent work platform during the glove manufacturing procedure.

The grooming glove 100 of the present invention may be formed from numerous off-tool glove samples for functional testing.

To develop a manufacturing process for the glove of the present invention, the nylon fabric glove liner 303 may be placed over the outside surface of a composite hand shaped, glove mandrel 301.

See FIG. 5.

The glove mandrel 301 is positioned inside a double sided vacuum injection mold 201 and configured to inject a temperature controlled heated liquid poly (vinyl chloride) PVC material onto the glove liner outer surface under pressure which causes the liquid to permeate, infuse and bond the palm pattern shape within the glove liner 303 during the vacuum injection molding of the palm pattern design.

See FIG. 7.

After sufficient time for cooling and curing to occur, the glove liner 303 remaining on the glove mandrel 301 is removed from the mold overlay during the cooling process.

The glove liner 303 is now infused with the PVC injected raised nodules or nubs in comb-like palm patterns; the glove liner 303 is again placed upon another hand shaped mandrel 301 which is moved through a multitude of glove half-palm surface depth dipping vats.

The first dipping vat is filled with liquid carbonyl chloride to cleanse off/remove any foreign surfaces oils or other pollutant residues from the prepared injection vacuum molded glove liner 303 prior to dipping the glove liner 303 in the next vat dipping phase of the liquid nitrile material. See FIGS. 4 & 9.

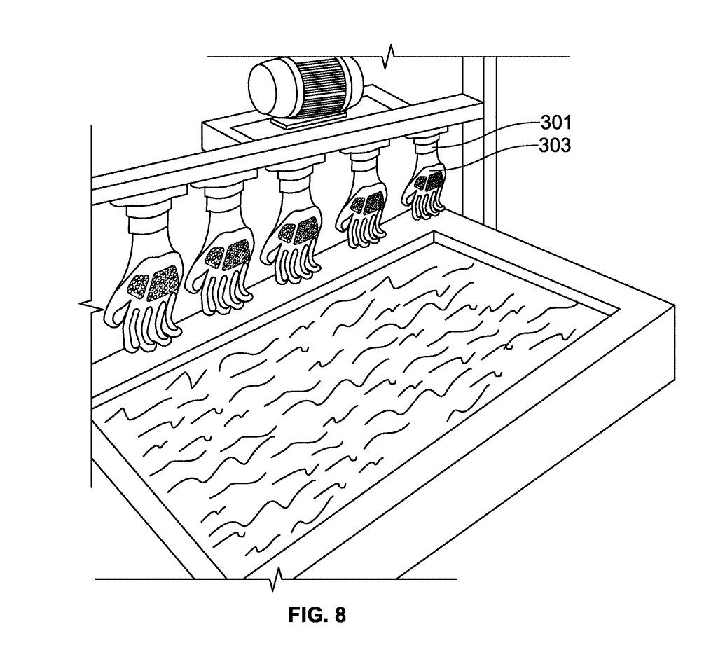

The infused glove liner 303 injected with the raised PVC nodules 115, 117 palm pattern is next half-dipped into a hot nitrile liquid vat bath including dipping of the fingers, thumb and palm surface 111, 107, 109 to a level of about one-half the gloved hand's depth from a side-view perspective. The glove liner 103 palm is facing downward toward the liquid bath of liquid nitrile rubber, The vat of nitrile rubber material is temperature controlled. See FIG. 8 which shows the nitrate dipping VAT 401 to add a nitrate rubber layer to the glove liner 303 mounted on the glove mandrel 301.

After the liquid nitrile vat dipping process is completed, the dipped liners 303 are placed for a short interval onto a framework station of glove liner mandrel holders 301 will which is then vibrated to insure even coating and drying by vibrating the new liquid coating during the cooling and resting phase during a short curing period following the liquid nitrile rubber dipping bath.

The glove mandrel 301 with the nitrile dipped glove liner in positioned afterward on a mechanical conveyer belt-fed platform moving the glove mandrels 301 through a series of hot air blowers and heaters in an oven chamber at a controlled heat interval of approximately 100-110 degrees for approximately 40 to 60 minutes which allows the finished dipped gloves 100 to plastify near completely.

The heated air drying and curing interval may be evenly spreading the cooling nitrile material onto the glove's various surfaces, helping to avoid runs or drips from forming on the glove's finger tips or palm surfaces during the cooling and curing period as the glove dries is in a rotating, fan driven hot air cooling process.

The finished and processed gloves 100 are afterward washed in a clean water bath and then removed from the glove mandrels 301 and to be forced air dried to prepare them for final packaging including printing the product logo and attaching the makers mark with country of manufacture origin tags descriptive of materials used in the manufacturing process. See FIG. 9. Final glove pairing, labeling, packaging and boxing for shipment are then completed.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A glove for grooming an animal, comprising;
a first surface having a first nodule;
a second surface having a second nodule;
a third surface having substantially no nodules.

2) A glove for grooming an animal as in claim 1, wherein the first nodule is cone shaped.

3) A glove for grooming an animal as in claim 1, wherein the second nodule includes a cone shaped base and a cylinder shaped finger extending from the base.

4) A glove for grooming an animal as in claim 1, wherein the glove is formed with a vacuum injection mold.

5) A glove for grooming an animal as in claim 4, wherein the vacuum injection mold includes a concave side.

6) A glove for grooming an animal as in claim 1, wherein the vacuum injection mold includes a convex side.

7) A glove for grooming an animal as in claim 1, wherein the glove is formed from a multitude of layers.

8) A glove for grooming an animal as in claim 1, wherein the third surface is positioned to allow a finger of the glove to be bent.

9) A glove for grooming an animal as in claim 1, wherein the glove is formed with a hot air blower.

10) A glove for grooming an animal as in claim 1, wherein the glove is formed with a heater.

11) A glove for grooming an animal as in claim 1, wherein the glove is washed in a clean water bath.

12) A glove for grooming an animal as in claim 1, wherein the glove is vibrated to insure an even coating.
